(19) United States
(12) Patent Application Publication
(10) Pub. No.: US 2016/0229701 A1
(43) Pub. Date: Aug. 11, 2016

(54) SPINEL SLURRY AND CASTING PROCESS

(71) Applicant: Corning Incorporated, Corning, NY (US)

(72) Inventors: Jennifer Anella Heine, Horseheads, NY (US); Weiguo Miao, Horseheads, NY (US); Nathan Michael Zink, Painted Post, NY (US)

(21) Appl. No.: 15/003,061

(22) Filed: Jan. 21, 2016

Related U.S. Application Data
(60) Provisional application No. 62/113,830, filed on Feb. 9, 2015.

(51) Int. Cl. C01F 7/16

(52) U.S. Cl. CPC C01F 7/162; C01P 2002/32; C01P 2004/62; C01P 2006/12

(57) ABSTRACT

A magnesium aluminate spinel nanopowder including:
a particle size of from 200 to 800 nm;
a median particle size of from 200 to 400 nm; and
a surface area by BET is from 2 to 10 m²/g.

Also disclosed is a method of making the nanopowder by co-precipitation and methods of use thereof, as defined herein.

### CROSS-REFERENCE TO PRIORITY APPLICATION

This application claims the benefit of priority under 35 U.S.C. §119 of U.S. Provisional Application Ser. No. 62/113,830 filed on Feb. 9, 2015, the content of which is relied upon and incorporated herein by reference in its entirety.

### CROSS-REFERENCE TO RELATED APPLICATIONS

The present application is related commonly owned and assigned U.S. Provisional Application Ser. No. 62/019,649, filed Jul. 1, 2014, entitled “TRANSPARENT SPINEL ARTICLE AND TAPE CAST METHODS FOR MAKING,” but does not claim priority thereto. The content of this document and the entire disclosure of any publication or patent document mentioned herein is incorporated by reference.

### BACKGROUND

The present disclosure generally relates to a tape casting method for making thin transparent spinel and laminate transparent spinel.

### SUMMARY

In embodiments, the present disclosure provides a spinel slurry and casting process having special powder requirements.

### BRIEF DESCRIPTION OF THE DRAWINGS

In embodiments of the disclosure:

FIGS. 1A to 1C show XRD results of spinel samples prepared at various temperatures of 1000° C. (1A); 1100° C. (1B); and 1200° C. (1C).

FIGS. 2A to 2D show SEM analysis for powder samples of S3OCR (2A), S15CR (2B), S10CR (2C), and S5CR (2D) (scale bar=2 microns).

FIG. 3 shows the PSD of the S5CR powder (solid and dashed lines).

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

In embodiments, the disclosed apparatus, and the disclosed method of making and using provide one or more advantageous features or aspects, including for example as discussed below. Features or aspects recited in any of the claims are generally applicable to all facets of the invention. Any recited single or multiple feature or aspect in any one claim can be combined or permuted with any other recited feature or aspect in any other claim or claims.

Definitions

“Volume percent solids loading,” “vol % solids loading,” “volume %”, or like expressions refer to the inorganic solids in the casted tape. Vol % solids loading only takes into account the inorganic components (i.e., spinel). Typical vol % solids loading can be, for example, from 45 to 65 vol %, from 50 to 65 vol %, from 55 to 65 vol %, from 60 to 65 vol %, including intermediate values and ranges.

“Tape green density” refers to the combination of the spinel powder (the inorganic component) and the binder system (the organic component) in the tape in g/cm³. Green density is a representation of the amount of porosity in the tape, which considers both the organic and inorganic components. Typical tape green density can be, for example, from 75 to 95% depending, for example, on the starting powder and organic content.

“Transmittance” refers to the fraction of incident light at a specified wavelength that passes through a sample.

“Transparency” refers to the property of the spinel that permits light to pass through without being scattered.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The composition and methods of the disclosure can include any value or any combination of the values, specific values, more specific values, and preferred values described herein, including explicit or implicit intermediate values and ranges.

In embodiments, the disclosure provides a magnesium aluminate spinel nanopowder comprising:

a particle size can be, for example, of from 200 to 800 nm;

a median particle size can be, for example, of from 200 to 400 nm; and

a surface area by BET can be, for example, from 2 to 10 m²/g.

In embodiments, the particle size can be, for example, from 200 to 600 nm; and the particle surface area can be, for example, from 4 to 10 m²/g.

In embodiments, the particle size can be, for example, from 200 to 400 nm; the median particle size can be, for example, from 250 to 350 nm; and the particle surface area can be, for example, from 6 to 8 m²/g.

In embodiments, the median particle size can be, for example, 300 nm.

In embodiments, the disclosure provides a method of making the disclosed magnesium aluminate spinel nanopowder, comprising:

contacting an aqueous solution of (NH₄)₂CO₃and an aqueous solution of a mixture of (NH₄)Al(SO₄)₂ and Mg(NO₃)₂ at about 45 to 55° C.;

aging the reaction mixture at about 45 to 55° C. for 5 to 15 hrs while mixing to produce a solid;

separating, washing, and drying, the resulting solid; and

sintering the resulting solid at from 1300 to 1500° C. to form a spinel product.

In embodiments, the contacting can comprise, for example, controlled addition the aqueous solution of a mixture of 0.5 mol % (NH₄)Al(SO₄)₂ and 0.25 mol % Mg(NO₃)₂ to the aqueous solution of 1.5 mol % (NH₄)₂CO₃ using a syringe pump.

In embodiments, the disclosure provides a method of slurry processing of spinel. The method begins with a low surface area of from 4 to 15 m²/g spinel powder to generate a high, for example, up to 55 vol % solid loading for a green body. The loaded green body in turn will be able to be sintered to transparency with the disclosed sintering method. In the abovementioned commonly owned and assigned copending application, the specification of a spinel powder having, for example, a preferred particle size of from 200 to 800 nm, was identified.

In embodiments, the present disclosure provides a method of making a spinel powder having a preferred particle size of from 200 to 800 nm for making thin, ceramic sheets sintered to transparency.

In embodiments, the present disclosure provides results that demonstrate the impact of spinel powder properties on the resulting solids loading.

Spinel powder, having an average particle size of from about 200 to 800 nm, and surface area of from 4 to 10 m²/g, was shown to generate the highest solid loading for the tape casting of spinel green bodies. Using tape casting and a lamination process, green body solid loading of from 46 to 55 vol % can be obtained for the spinel parts.

The disclosed co-precipitation method was used to make the spinel precursor. Different calcination temperatures were used to get the different spinel particle sizes. The disclosed co-precipitation method demonstrated an ability to generate spinel powder at the proper particle size range for various slurry processes.

The slurry processes can include many kinds of processes, for example, tape casting, slip casting, gel-casting, pressure casting, centrifuge casting, and like processes, or combinations thereof.

The present disclosure is advantaged is several aspects, including for example:

The disclosed tape casting method allows for the formation of transparent spinel without the use of sintering aids.

The disclosed tape casting method allows for decreasing the grain size of the casting material, and provides an increase in the strength compared to other commercially available spinels.

The disclosed tape casting method can be accomplished on a production scale.

The disclosed tape casting method can be accomplished at a low cost, which is evident by the billion units of multilayer capacitor (MLC) made annually at an ultra-low commodity price. The tape casting manufacturing process compared favorably to other commercially available processes. A material with similar properties to sapphire can be prepared at a fraction of the cost, such as less than 80% of the sapphire price.

The disclosed tape casting method can provide flexibility to make parts having different thicknesses due to lamination.

The disclosed tape casting method can make large, thin, flat, sheets for consumer electronics applications.

While tape casting is a well-established ceramic forming technique, the prior art is very limited regarding tape casting of spinel.

The disclosed tape casting method is believed to provide a fabrication route, which realizes one or more of the above advantages. Until recently water based binder systems were not available to create high density tapes.

Tape casting is a widely used method in the electronic package industry, so tape casting equipment is readily available. By using a spinel powder having a low surface area, it was possible to achieve high solids loading (for example, up to 55 vol %), which enables the sintering of the transparent spinel. The slurry process can also be used for slip casting, gel-casting, pressure casting, long as the desired spinel powder is used in the process.

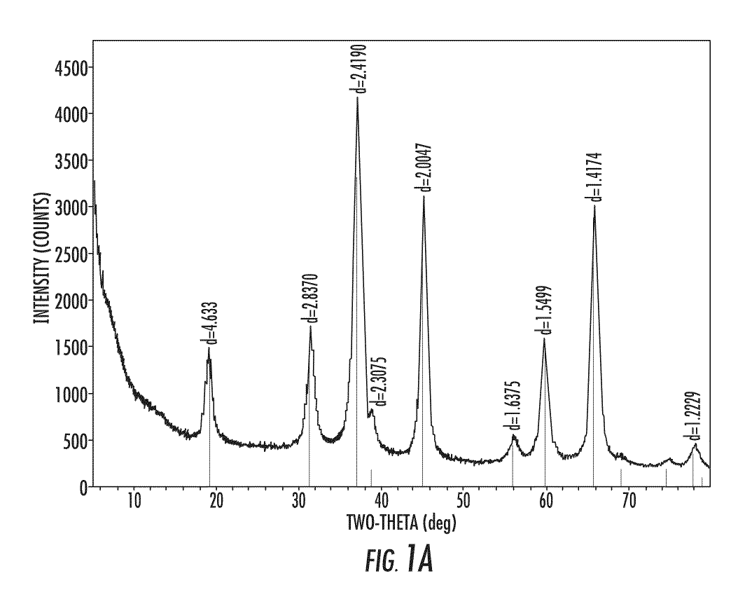

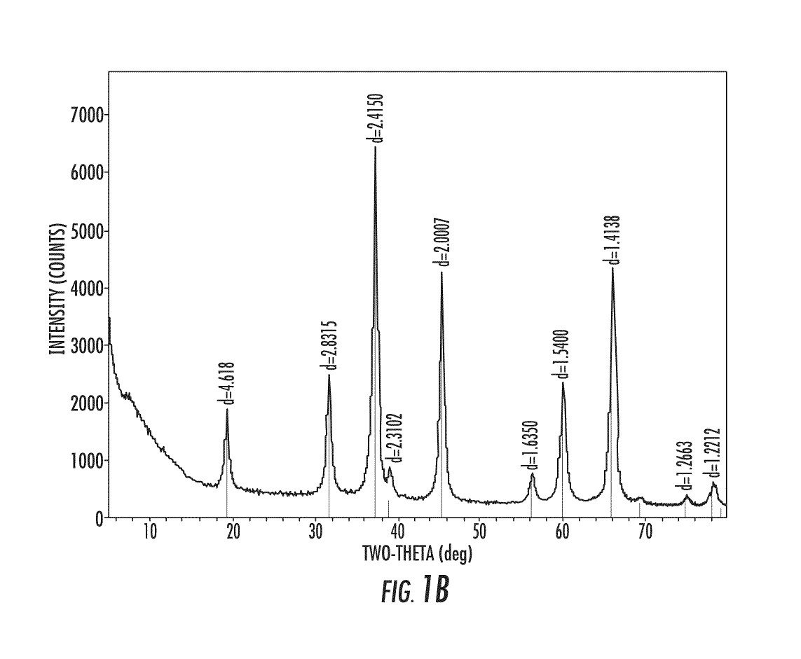

FIGS. 1A to 1C show XRD results of spinel samples prepared at various temperatures of 1000° C. (1A); 1100° C. (1B); and 1200° C. (1C).

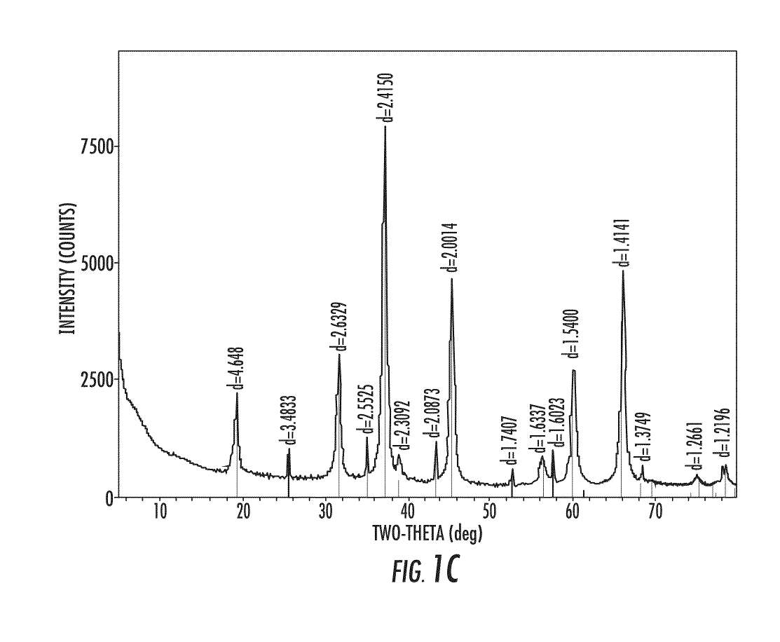

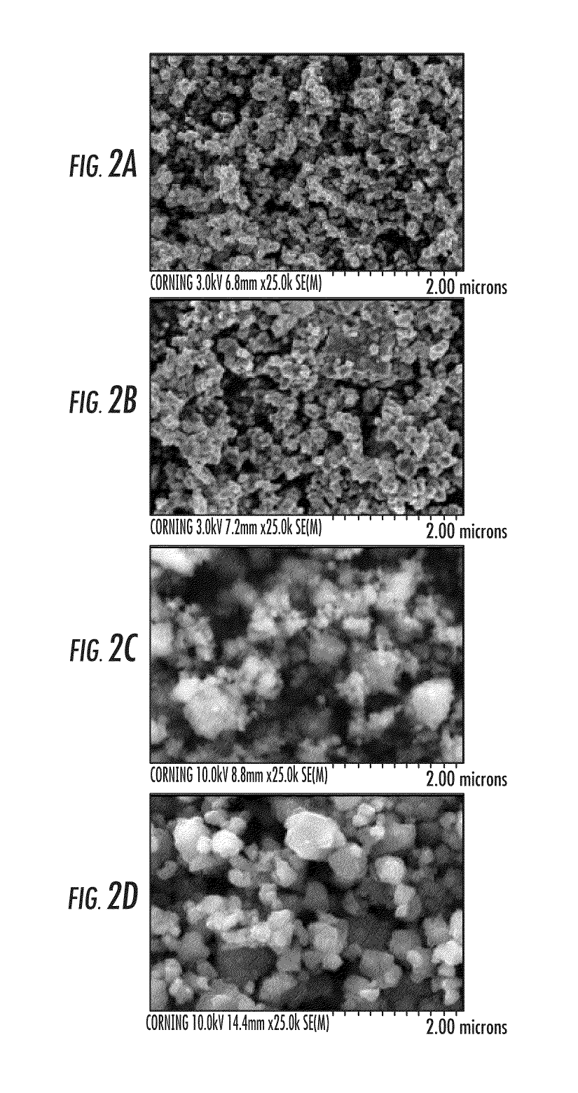

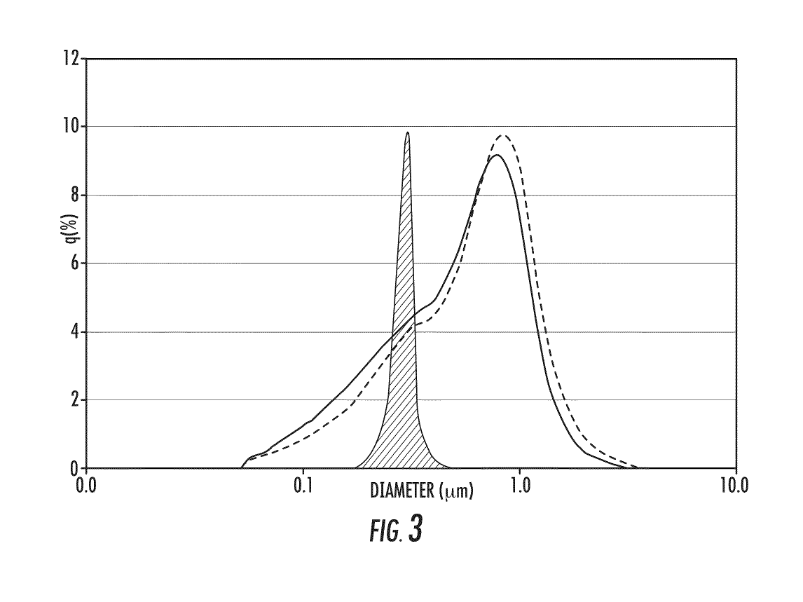

FIGS. 2A to 2D show SEM analysis for powder samples of S3OCR (2A), S15CR (2B), S10CR (2C), and S5CR (2D) (scale bar=2 microns).

FIG. 3 shows the PSD of the S5CR powder (solid and dashed lines). The S5CR powder was similar to the S 10CR powder. The S5CR powder had a large PSD and did not allow for sintering to translucency. The shaded peak area is a projection of what is desired for improving the sinterability of a powder.

Table 1 lists the powder properties of the four powders tested, and shows SEM images of each powder.

The S30CR powder has an extremely high surface area (SA), so the tape requires a high amount of binder to prevent cracking during drying. Each particle must be surrounded by organic material to prevent cracking. With the high binder content the maximum solids loading in the tape is only about 35 volume % (vol %), which is too low to sinter transparent spinel.

The S10CR has a higher SA, but non-uniform particle size distribution (PSD), as can been seen in the SEM images. The PSD is bimodal, having large particles of up to 1 micron, which reduces the overall packing efficiency of the powder and does not permit uniform sintering.

The S15CR powder has a narrow PSD and relatively low SA, which allows for good tape formation and sintering.

The S5CR powder has a decreased specific surface area (SSA) while maintaining a narrow PSD and should permit improved sintering over the S15CR powder.

TABLE 1

| | Powder Name | | | |
|---|---|---|---|---|
| Powder Properties | S30CR | S15CR | S10CR | S5CR |
| BET SSA (m²/g) | 30.4 | 15.4 | 10.5 | 5.5 |
| Median d (microns) | 1.147 | 2.121 | N/A | N/A |
| d90 | N/A | N/A | 1.040 | 1.030 |
| d50 | N/A | N/A | 0.280 | 0.530 |
| d10 | N/A | N/A | 0.100 | 0.150 |

Table 2 lists the chemical analysis (purity level) of the powder samples of the four powder tested.

TABLE 2

| | S30CR | S15CR | S10CR | S5CR |
|---|---|---|---|---|
| Na | 40 | 34 | 8.8 | 10 |
| K | 100 | N/A | 19 | 15 |
| Fe | 2 | 7 | 5.6 | 6.7 |
| Si | 33 | 26 | 43 | 33 |
| Ca | 12 | 6 | 6 | 2.9 |

An example batch composition for a tape cast slurry is given in Table 3. Table 4 provides a listing of the components and their source. These organic chemicals are formulated for aqueous ceramic tape casting by Polymer Innovations, Inc, of Vista, Calif.

The quantities of each tape component described below are significant in forming a superior tape that does not crack, has a high green density, and can be laminated together with other like spinel tapes or other tapes.

TABLE 3

| | | Volume | Weight |
|---|---|---|---|
| | | Percent | Percent |
| Component | Density | (%) | (%) |
| Water | 1.00 | 60.25 | 42.82 |
| NH₄OH | 1.00 | 3.32 | 2.36 |
| WB4101 | 1.03 | 18.28 | 13.38 |
| PL005 | 1.03 | 1.08 | 0.79 |
| DF002 | 1.20 | 0.19 | 0.16 |
| DS001 | 1.03 | 1.72 | 1.26 |
| MgAl₂O₄ | 3.64 | 15.16 | 39.23 |

WB4101 is an acrylic binder with additives in the solution.
DF002 is a non-silicone de-foaming agent.
DS001 is a polymeric dispersant.
PL005 is a high pH plasticizer.

TABLE 4

| Component | Name | Source |
|---|---|---|
| WB4101 | binder | Polymer Innovations |
| NH₄OH | ammonia | — |
| PL005 | plasticizer | Polymer Innovations |
| DF002 | defoamer | Polymer Innovations |
| DS001 | dispersant | Polymer Innovations |
| MgAl₂O4 | S15CR | Baikowski |

### EXAMPLES

The following Examples demonstrate making, use, and analysis of the disclosed spinel articles in accordance with the above general procedures.

### Example 1

Process for making spinel nano powder The co-precipitation process used to make a magnesium aluminate spinel (MgAl₂O₄) nanopowder, or a solid solution of Al₂O₃ and MgO, begins with creating an aqueous solution containing the desired reactants in amounts corresponding to the stoichiometry of the intended metal oxide. The magnesium aluminate spinel (MgAl₂O₄) nanopowder and the solid solution of Al₂O₃ and MgO are both nano-powders, but they have different material phases present in the two materials as shown in the XRD data FIGS. 2A to 2C. They are essentially the same with respect to powder size and properties.

For magnesium aluminate spinel, this is 0.5 mol % (NH₄)Al(SO₄)₂ and 0.25 mol % Mg(NO₃)₂. This reactant solution has a pH of about 3. A separate aqueous solution of 1.5 mol % (NH₄)₂CO₃ is prepared which has a pH of about 9. This solution is placed in a beaker in at 50° C. circulated water bath to ensure uniform temperature while continually mixing. The solution of (NH₄)Al(SO₄)₂ and Mg(NO₃)₂ is placed in a reservoir. A syringe pump draws from the reservoir at a controlled flow rate of 15 mL/min and sends the reactant solution to the (NH₄)₂CO₃ precipitant solution until a pH of 8 is reached. The resulting dispersion is aged at 50° C. for 10 hrs while mixing. The dispersion is then centrifuged, decanted, and the solid residue rinsed 3 times with water to remove some of the residual salts, and once with ethanol to create the spinel precursor. The precursor is then placed in a hot air dryer at 50° C. for 16 hours. The dried precursor is then calcined to various temperatures and times to create the final spinel. The time and temperature of the calcining step has a significant impact on particle size of the final product and its purity. Higher temperatures result in larger crystal growth. The results of the particle sizes and surface areas achieved at various temperatures are listed in Table 5.

TABLE 5

| | | | BET | | |
|---|---|---|---|---|---|
| | | | (multi- | | |
| | | | point) | | |
| | Temperature | Sample | Surface | Single Point | Particle |
| Sample | (° C.)/Time | Weight | Area | Surface Area | Size |
| ID | (hrs) | (g) | (m²/g) | (m₂/g) | (nm) |
| 1 | 1000/4 | 0.19 | 121.78 | 120.04 | 13.76 |
| 2 | 1100/4 | 0.25 | 72.30 | 71.42 | 23.18 |
| 3 | 1200/4 | 0.24 | 23.95 | 23.63 | 69.98 |
| 4 | 1300/4 | 0.37 | 10.23 | 10.04 | 163.80 |
| 5 | 1400/4 | 0.58 | 5.11 | 5.02 | 327.90 |
| 6 | 1500/4 | 0.43 | 2.43 | 2.38 | 690.80 |

The particle size can be calculated from the surface area by the formula:

d=6*10³/(ρ·S_{BET})

where d is the average particle size (in nm), ρ is the density of spinel (3.58 g/cm³), S_{BET} is the measured surface area (in m²/g) This formula assumes the particles are spherical.

For comparison, a conventional tape casting process and apparatus are disclosed and illustrated in “Principles of Ceramic Processing” by James S. Reed, 1995, 2^{nd} Ed., ISBN-13: 978-0471597216.

The disclosure has been described with reference to various specific embodiments and techniques. However, many variations and modifications are possible while remaining within the scope of the disclosure.

What is claimed:

1. A magnesium aluminate spinel nanopowder comprising:
a particle size of from 200 to 800 nm;
a median particle size of from 200 to 400 nm; and
a surface area by BET is from 2 to 10 m²/g.

2. The nanopowder of claim 1 wherein:
the particle size is from 200 to 600 nm; and
the particle surface area is from 4 to 10 m²/g.

3. The nanopowder of claim 1 wherein:
the particle size is from 200 to 400 nm;
the median particle size is from 250 to 350 nm; and
the particle surface area is from 6 to 8 m²/g.

4. The nanopowder of claim 1 wherein the median particle size is 300 nm.

5. A method of making the magnesium aluminate spinel nanopowder of claim 1, comprising:
contacting an aqueous solution of (NH₄)₂CO₃and an aqueous solution of a mixture of (NH₄)Al(SO₄)₂ and Mg(NO₃)₂ at about 45 to 55° C.;
aging the reaction mixture at about 45 to 55° C. for 5 to 15 hrs while mixing to produce a solid;
separating, washing, and drying, the resulting solid; and
sintering the resulting solid at from 1300 to 1500° C. to form a spinel product.

6. The method of claim 5 wherein the contacting comprising controlled addition the aqueous solution of a mixture of 0.5 mol % (NH₄)Al(SO₄)₂ and 0.25 mol % Mg(NO₃)₂to the aqueous solution of 1.5 mol % (NH₄)₂CO₃ using a syringe pump.
